(19) United States
(12) Patent Application Publication
(10) Pub. No.: US 2013/0051545 A1
(43) Pub. Date: Feb. 28, 2013

(54) CALL CENTER SYSTEM FOR DYNAMIC DETERMINATION OF APPROPRIATE REPRESENTATIVE

(71) Applicants: Erik Stephen Ross, Charlotte, NC (US); Matthew A. Calman, Charlotte, NC (US)

(72) Inventors: Erik Stephen Ross, Charlotte, NC (US); Matthew A. Calman, Charlotte, NC (US)

(73) Assignee: BANK OF AMERICA CORPORATION, Charlotte, NC (US)

(21) Appl. No.: 13/218,117

(22) Filed: Aug. 25, 2011

(51) Int. Cl. H04M 3/00

(52) U.S. Cl. 379/265.02

(57) ABSTRACT

Embodiments of the invention are directed to a call center system for dynamically determining an appropriate customer service representative, and more particularly embodiments of the invention are directed to methods, apparatuses, and computer program products for providing a match between a customer and a customer service representative based on indicators from both the customer and the customer service representative. The indicators may include voice indicators, behavioral indicators, location indicators, personality indicators and the like. In this way, the customer service representative most appropriate to field the customer's call may be queue to receive the customer's call.

### BACKGROUND

Customers trying to obtain expertise regarding products or services that they wish to purchase, have previously purchased, or have used often contact manufacturer or merchant customer service representatives by visiting a location convenient to them, visiting the location where the customer obtained the product or service, or calling customer service representatives over the telephone.

Store locations have limited resources to provide customer service representatives that are able to serve the needs of the store's customers. Furthermore, it may be impractical for store locations to utilize such representatives due to the timing of the needs of the customer, the limited demand for a representative with specialized knowledge, it not being cost effective for all store locations to include a customer representative on location.

Call centers are often set up in a supporting role so that customers speak anytime over the phone to a customer representative that is able to meet each customers' specific needs or questions. However, customers may be reluctant to contact call centers due to the amount of time the customer may have to wait to speak with a representative or the inability for the representative to accurately support the customer and his needs, or the way the customer perceives he or she is treated by the customer service representative.

In a traditional call center, customer service representatives answer calls in the order in which they are received. Once the customer call is placed in a queue for answering, a representative answers the call. The representative answers a call from a customer based on the order in which the call was received and may have no knowledge of the customer's needs prior to fielding the call. The representative may need to spend several minutes discussing the customer's needs with the customer prior to determining a solution. In some cases, the representative may need to transfer the customer to a second representative with more knowledge related to the customer's needs. Further, the customer may be angry because the product is malfunctioning, thus continuing to be placed on hold may further escalate the anger of the customer.

To this end, there is always a demand for a call center to provide satisfying service to all customers that call the call center.

### BRIEF SUMMARY

Embodiments of the present invention address the above needs and/or achieve other advantages by providing apparatuses (e.g., a system, computer program product, and/or other devices) and methods for a call center to dynamically determine the appropriate customer service representative for a customer based on indicators relating to the disposition of both the customer and the customer service representative prior to and during the customer communications. An indication of the disposition of an individual provides a personality match between the customer and the customer service representative, such that there is not a clash between the customer and the customer service representative with respect to personality characteristics and interests. This allows a call center to match customers with the appropriate customer service representative based on a prediction of the disposition of the customer and the customer service representative. The appropriate customer service representative may provide a positive call center experience for the customer. In some embodiments, the call center system may measure indicators from the customer to determine the customer's disposition. The customer's disposition may then be matched with indicators from customer service representatives to predict an appropriate customer service representative for the customer's call to be routed to. In this way, the customer's call will routed to the customer service station where the appropriate customer service representative is located. The appropriate customer service representative is one that is predicted to not be in conflict with the disposition of the customer. In some embodiments, the call center system may measure indicators from the customer service representative to predict the customer service representative's disposition, so that the appropriate customer is matched to the appropriate customer service representative.

Embodiments of the invention allow a call center to match a customer with a customer service representative based on the predicted customer's and/or customer service representative's disposition. The disposition may include, but is not limited to the individual's stress level, mood, anger level, or overall behavior. The disposition is measured by historical data and current data of both the customer and the customer service representative. In this way, the customer is matched with the customer service representative that would best support the customer and prevent escalating anger of a customer.

When a communication is received from a customer at a call center, the customer can provide an indication as to why he is contacting the call center. The indication from the customer may be analyzed for indicators as to the customer's disposition, to predict and attempt to match the customer with an appropriate customer service representative. The indicators analyzed may include current and/or historical indicators. Current indicators may include, but are not limited to voice data of the customer, social network data of the customer, behavioral measures of the customer, and/or location data of the customer. Indicators may also include historical indicators of the customer. Historical indicators may include, but are not limited to customer call history, customer transaction history, personal data of the customer, and/or customer interests.

Once customer indicators are analyzed the call center system may match the customer with a customer service representative that most similarly matches those customer indicators. Thus, indicators of the disposition of a customer service representative are also analyzed. An analysis of customer service representative indicators may include an analysis of current and historical indicators of the customer service representative. Customer service representative current indicators may include, but are not limited to current stress level, recent call outcomes, and/or current voice data. Customer service representative historical indicators may include, but are not limited to personality test data, risk test data, product expertise data, experience data, and/or personal data.

After customer indicators are analyzed and customer service representative indicators are analyzed, a match between a customer and a customer service representative is predicted. The match is based on the disposition of both the customer and the customer service representative at the time of the call. The matched customer calls may be placed in a queue for the customer service representative to answer the customer's call with whom the customer service representative is matched. The customer service representative may then receive an indication of the match and data relating to the customer. The customer service representative may then accept the customer's call.

The dynamic determination of a customer and a customer service representative, based on customer and customer service representative indicators provides the best match between a customer and customer service representative, such that it increases the probability of the customer receiving satisfactory customer service from the call center.

More particularly, embodiments of the present invention are directed to a method, system, and computer program product for routing an incoming customer communication to a customer service station in a customer service network, comprising: receiving an incoming customer communication; determining a reason for the customer communication; analyzing one or more customer indicators, through the use of a processing device, to predict the customer's disposition; analyzing individual representative disposition indicators associated with one or more customer representatives to predict the one or more customer representative's disposition; determining a selected customer representative having a predicted disposition that is predicted to not conflict with the customer's predicted disposition; and routing the incoming customer communication to the customer service station associated with the selected customer representative.

In some embodiments, determining the reason for the customer communication may be based at least in part on customer transaction history. The customer transaction history may include prior purchases by the customer of products or services, wherein customer service for the products or services is provided by the customer representative of the customer service network.

In some embodiments, determining the reason for the customer communication is based at least in part on the customer communication. Along with determining the reasons for the customer communication, customer indicators are analyzed. Customer indicators include voice frequency of the customer, such that a prediction is made at least partially from the customer's voice frequency as to the customer's disposition. Customer indicators may further include customer calling history, such that the disposition of the customer during prior communications provides a prediction of the customer's disposition during a subsequent communication. Customer indicators may also include customer Internet browsing, such that social network data or browsing data of the customer provides a prediction of the customer's disposition.

In some embodiments, the customer representative indicators include an analysis of the customer representative's recent communications with customers, such that an indication is provided of the customer representative disposition based on an outcome of recent customer communications. Customer representative indicators may further include personality test data of the customer representatives. In some embodiments, the customer representative is an individual. In yet other embodiments, the customer representative is an automated voice system.

In some embodiments, the selected customer representative is provided information regarding the customer's disposition, such that the selected customer representative is prepared for the customer when the customer communication is routed to the customer service station of the selected customer representative.

In some embodiments, the selected customer representative, in response to the information received regarding the customer's disposition, may accept the routed communication from the customer or may reject the customer communication so that it can be resolved elsewhere in the customer service network.

### BRIEF DESCRIPTION OF THE DRAWINGS

Having thus described embodiments of the invention in general terms, reference will now be made the accompanying drawings, wherein:

FIG. 1 provides a high level process flow illustrating a customer service representative matching program process, in accordance with one embodiment of the present invention;

FIG. 2 provides customer service representative matching program system and environment, in accordance with one embodiment of the present invention;

FIG. 3 provides a high level process flow illustrating a customer service representative matching program process using manufacturer assessable data, in accordance with one embodiment of the present invention;

FIG. 4 provides a process flow illustrating a customer service representative matching program indicator analysis, in accordance with one embodiment of the present invention;

FIG. 5 provides a high level process flow illustrating a customer service representative matching program queuing process, in accordance with one embodiment of the present invention; and

FIG. 6 provides a customer service representative customer call interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “call center,” one of ordinary skill in the art will appreciate that other embodiments of the invention may involve other businesses that take the place of or work in conjunction with the call center to perform one or more of the processes or steps described herein as being performed by a call center. The call center may be any location where a business may receive customer communications regarding the business' products, services, etc., such that the call center may provide service to a customer.

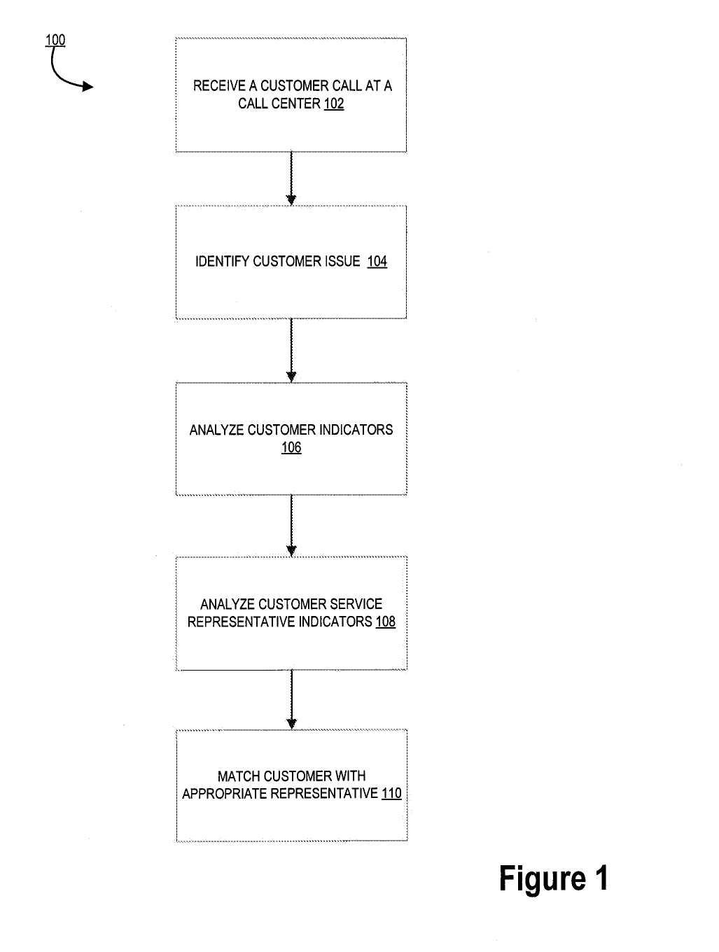

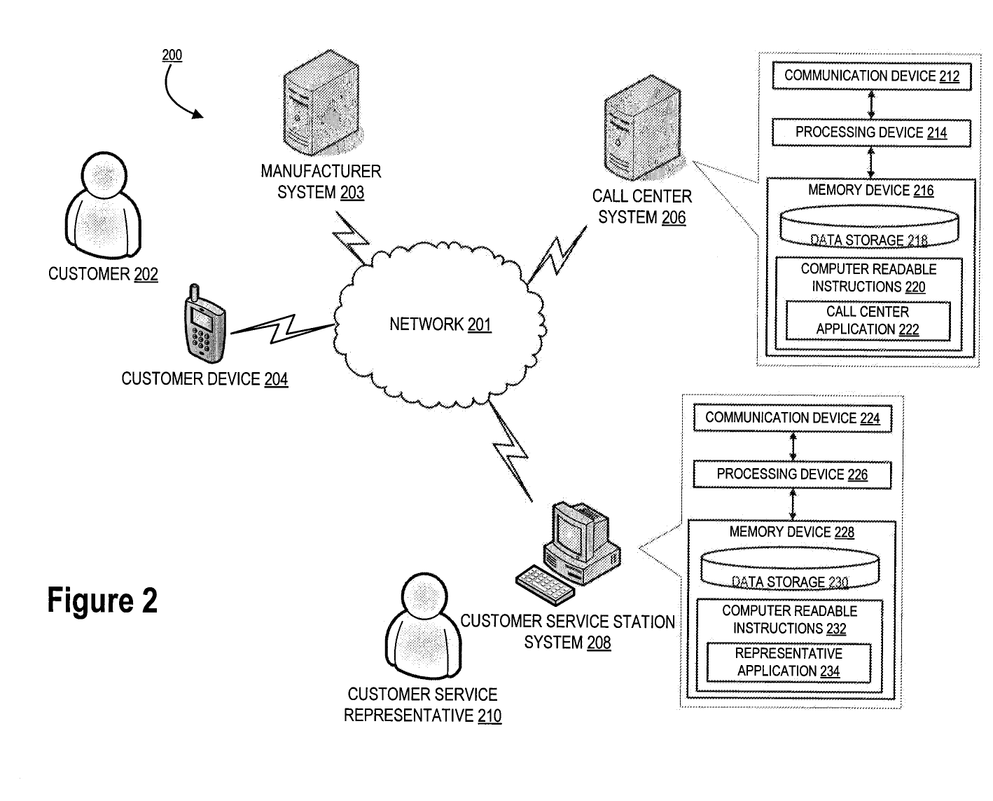

FIG. 1 illustrates a high level process flow illustrating a customer service representative matching program process 100 for matching a customer with the appropriate customer service representative, which will be discussed in further detail throughout this specification with respect to FIG. 2 through FIG. 6. As illustrated in block 102, the customer service representative matching program process 100 according to one embodiment includes receiving, at a call center, a customer call. A customer call may be in the form of a telephone call, email, text message, video message, or other types of communication methods available to the customer to communicate to a call center.

Once the call center receives the call as illustrated in block 102, the customer's issue(s) (i.e., the reason the customer is calling the call center) is identified as illustrated in block 104. In this way, the call center may determine why the customer is calling the call center. The customer issue may be provided by the customer or by a review of customer indicators. Indications of customer issues are provided by the customer by answering automated questions, by product survey responses, by warranty submissions, by voice communications, by text communications, by video communications, and/or the like. Customer issues may also be determined by an automated system, operators, or customer service representatives. In this way, a customer may communicate the reason he is calling using several different means of communication, including but not limited to voice, text, video, or other communication means.

Indentifying the customer's issue provides the call center system the ability to determine why the customer is calling. For example, one customer may be calling because of a defect in a product while another customer may be calling about issues with customer service at a local store. Each of these customers may require unique customer service representatives to field the different issues. In this example, one issue with a defect in the product and the other issue with a defect in customer service at a local store.

Once the customer issue is determined, the call center system may analyze customer indicators as represented in block 106. Customer indicators may be current and/or historical indicators. Customer indicators may be matched with customer service representatives' indicators once the call center staff indicators are analyzed in block 108.

After the customer issue has been identified 104, customer indicators have been analyzed 106, and customer service representative indicators have been analyzed 108, a match is determined between the customer and an appropriate customer service representative in block 110. In this way, the indicators from the customer and the indicators from the customer service representative may be compared and the best available customer service representative may be matched with the appropriate customer and the appropriate customer issue. Once the customer is matched with the appropriate customer service representative, the call from the customer may be placed in a queue for routing the call to the appropriate customer service representative. In other embodiments, the call from the customer may be directly routed to a customer service representative. The customer service representative may also receive information regarding the customer, information regarding the customer's issue, and information regarding the customer's indicators, prior to the customer service representative fielding the call from the customer.

FIG. 2 illustrates a customer service representative match program system environment 200, in accordance with one embodiment of the present invention. As illustrated in FIG. 2, the call center system 206 is operatively coupled, via a network 201 to the customer service station system 208, the manufacturer system 203, and the customer device 204. In this way, the call center system 206 can send and receive information to and from the customer service station system 208, the manufacturer system 203, and the customer device 204, to facilitate the matching of a customer with the appropriate customer service representative. FIG. 2 illustrates only one example of an embodiment of a dynamic determination of a customer service representative program system and environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination of wireline and wireless communication between devices on the network.

In some embodiments, the customer 202 is an individual that has a connection with the products or services that the call center represents and may desire to contact the call center in regards to the products or services. In some embodiments, the customer 202 is a merchant that has a connection to the products or services that the call center represents and may desire to contact the call center in regards to the products or services. In yet other embodiments, the customer 202 may not have a connection with any products or services, but may wish to contact a call center for information. The information may be based on any product, service, business, manufacturer, entity, financial institution, or the like, that the call center provides call receiving capabilities for.

The call center may provide call receiving capabilities for entities, such as but not limited to vendors, products, businesses, manufacturers, financial institutions, or the like. In some embodiments, the call center may be associated with the entity and in other embodiments, the call center may be the entity. In yet other embodiments, the call center may be independent of the entity. For example, the call center may provide customer service functionality for products provided by a manufacturer. In this way, a customer 202 who has purchased a manufacturer's product and may be directed to contact the call center if an issue arises with that manufacturer's product. In another example, the call center may provide call receiving capabilities for services. The services may be provided by any number of entities, including, but not limited to retailers, financial institutions, business entities, merchants, and/or the like. For example, a customer 202 may have an issue regarding an investment with a financial institution. The customer 202 may be directed to the call center, such that the call center may answer the customer's questions regarding the investment.

In some embodiments, the customer service representative 210 is an individual that receives calls at a call center. The customer service representative 210 may have specific expertise in which to provide assist customers 202 with issues regarding products, services, or the like. In some embodiments, the customer service representative 210 may be a system or machine capable of audio response. For example, the customer service representative 210 may be a natural language processing (“NLP”) system. The NLP system may understand and recognized the customer's 202 issue and provide a response based on the customer's 202 indications. In this way, the customer 202 may be provided a response to his issue from an automated system, such that the automated system provides the response that is unique to the customer's 202 reasoning for calling the call center. In this way, the NLP system may adapt to the customer's 202 indicators, such that the NLP system may provide a positive experience for a customer 202 no matter the customer's 202 rationale for calling the call center.

As illustrated in FIG. 2, the call center system 206 generally comprises a communication device 212, a processing device 214, and a memory device 216. As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 214 is operatively coupled to the communication device 212 and the memory device 216. The processing device 214 uses the communication device 212 to communicate with the network 201 and other devices on the network 201, such as, but not limited to the customer service station system 208, manufacturer system 203, and the customer device 204. As such, the communication device 224 generally comprises a modem, server, or other device for communicating with other devices on the network 201.

As illustrated in FIG. 2, the call center system 206 comprises computer-readable instructions 220 stored in the memory device 216, which in one embodiment includes computer-readable instructions 220 for a call center application 222. In some embodiments, the memory device 216 includes data storage 218 for storing data related to the dynamic determination of appropriate customer service representative program including, but not limited to the data created and/or used by the call center application 222.

As illustrated in FIG. 2 and described throughout much of this specification, the call center applications 222 provides an analysis of indicators, such that a match between the customer 202 and the customer service representative 210 may be made. Prior to providing the analysis of customer indicators, the call center application 222 may determine the issue for which a customer 202 is contacting the call center. A customer 202 may contact the call center using a verity of methods. This disclosure is writing in terms of a customer 202 contacting the call center via “calling” the call center. However, a customer 202 may contact the call center in several ways, including but not limited to a telephone call, emailing, text messaging, video messaging, or other types of communication methods available to the customer 202.

In some embodiments, the call center application 222 allows for identification issues for which the customer 202 is calling the call center. As explained above, the call center may field calls from customers 202 of many different entities. Because of this, the issue for which the customer 202 is contacting the call center may not be known to the call center upon receiving a call from the customer 202. The call center may provide a means of identifying the customer issue. The customer issue may arise from any customer 202 relation with an entity using the call center for means of support. In this way, the customer 202 may be calling about any product, service, etc. that the entity may provide. The call center may determine the issue the customer 202 is calling the call center using many means, including but not limited to, automated questions, keypad indicators, an NLP system, an operator, product survey responses, warranty submissions, voice communications, text communications, video communications, and/or the like.

In some embodiments, as explained in further detail below, the call center application 222 may gather and provide an analysis of customer indicators. Customer indicators may be received by the call center application 222 from the customer 202 through the use of the customer device 204, the manufacturer system 203, and/or the customer service station system 208. Customer indicators may comprise indicators of both current and/or historical and aid in determining the customer's disposition. Current indicators may included, but are not limited to voice data of the customer, social network data of the customer, behavioral measures of the customer, and/or location data of the customer. For example, the call center application 222 may provide computer readable instructions 220 to determine the disposition of the customer 202 based on voice data, such as voice frequency, voice urgency, speech speed, the words used by the customer 202, and the like. Historical indicators may include, but are not limited to customer call history, customer transaction history, personal data of the customer, and/or customer interests. For example, the call center application 222 may have previously stored data in the memory device 216 regarding previous calls from the customer 202. The call center application 222 may review the previous calls in order to predict the customer's current issue (i.e., the customer may be calling regarding the same or similar product as he has previously called about) or the customer's disposition (i.e., last time the customer called, he was calm discussing the issue).

The call center application 222 gathers and provides analysis of customer service representative indicators. Customer service representative indicators may also be current and/or historical. In some embodiments, the call center application 222 may receive customer service representative indicators from the customer service station system 208. In other embodiments, the call center application 222 may provide customer service representative indicators. Customer service representative current indicators may include, but are not limited to current stress level, recent call outcomes, and/or current voice data. Customer service representative historical indicators may include, but are not limited to personality test data, risk test data, product expertise data, experience data, and personal data.

In some embodiments, the call center application 222 may provide comparative analysis of the customer indicators and the customer service representative indicators. In this way, the call center application 222 may provide a match between a customer 202 and a customer service representative 210 based on the indicators. This process matches the customer 202 with the most suitable customer service representative 210 for solving the customer's issue. The call center application 222 may place the matched customer calls in a queue for the customer service representatives to answer the customer's call. In some embodiments, the call center application 222 may match a customer 202 with a customer service representative 210 based on all of the indicators analyzed. In some embodiments, specific indicators may take priority over other indicators when a selection is being made. In this way, a customer service representative 210 may be selected based on the fact that he has the most expertise in the field of the issue the customer 202 is calling in regard to. For example, if a customer 202 has a specific technical question regarding a product, say a computer product, the call center application 222 may determine the appropriate customer service representative 210 that is knowledgeable with respect to that specific computer product. In some embodiments, a single indicator analysis may result in the match of a customer 202 with a customer service representative 210. For example, caller history of the customer 202 may be analyzed to predict outcomes of the current call. In this way, the call center application 222 may review caller history and route the call to a customer service representative 210 that the customer 202 has had a positive experience with in the past. In yet other embodiments, the analysis from multiple indicators may result in the match of a customer 202 with a customer service representative 210. For example, the disposition of the customer 202 may be analyzed to match the disposition of a customer service representative 210 at the current time. In this way, the call center application 222 may determine the disposition of the customer 202, such as the personality type, stress level, anger level, and/or the like of the customer 202. For example, it may be determined from the indicators that the customer 202 has a type A personality. Personality matching may indicate that a type A personality may not match with another type A personality, therefore the call center application 222 may route the customer 202 to a customer service representative 210 that does not have a type A personality.

Once the call center application 222 determines an appropriate match based on the customer 202 and the customer service representative 210 indicators, the call center application 222 allows for the customer 202 call to be routed to and placed in a queue at the customer service station system 208 for the customer service representative 210 to answer. The customer service representative 210 may receive information on the customer service station system 208 of a customer 202 call being routed to him. The information on the customer service station system 208 may display information regarding the indicators of the customer 202.

As illustrated in FIG. 2, the customer service station system 208 is generally comprised of a communication device 224, a processing device 226, and a memory device 228. The processing device 226 uses the communication device 224 to communicate with the network 201 and other devices on the network 201, such as, but not limited to the call center system 206, the customer device 204, and the manufacturer system 203. As such, the communication device 224 generally comprises a modem, server, or other device for communicating with other devices on the network 201. The communication device 224 may also provide for voice communications along the network 201, such that the customer service representative 210 may use the customer service station system 208 to speak to a customer 202 using a customer device 204.

As illustrated in FIG. 2, the customer service station system 208 comprises computer-readable instructions 232 stored in the memory device 228, which in one embodiment includes computer-readable instructions 232 for a representative application 234. In some embodiments, the memory device 228 includes data storage 230 for storing data related to the dynamic determination of an appropriate customer service representative program including, but not limited to data created and/or used by the representative application 234.

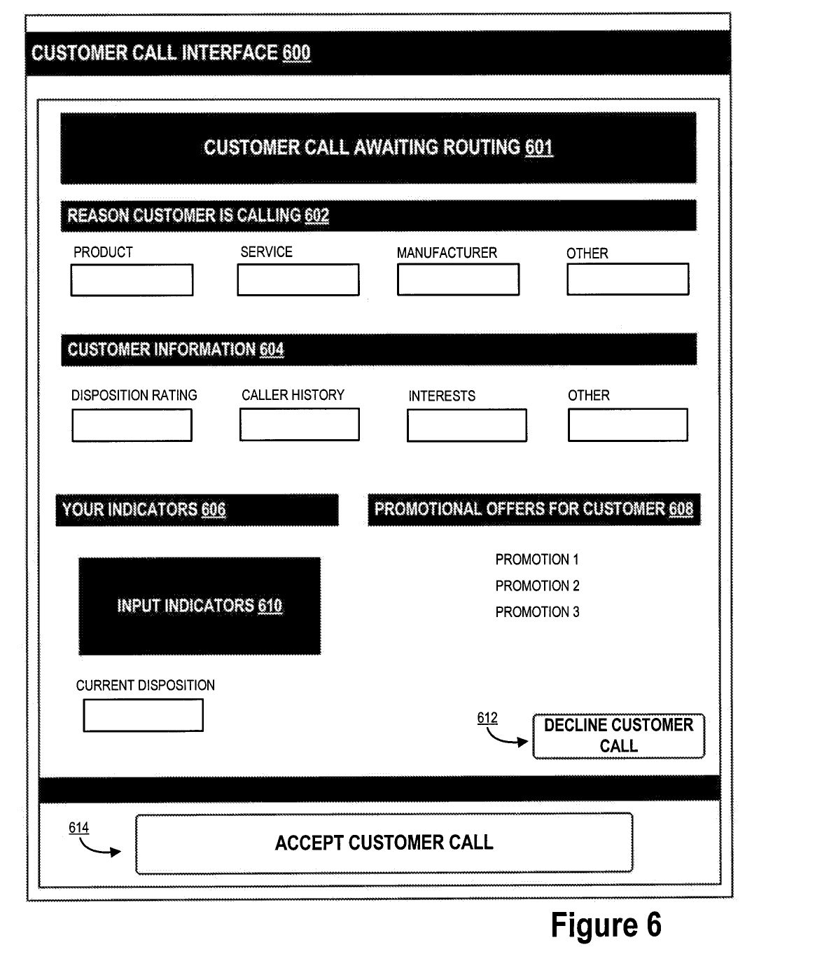

In the embodiment illustrated in FIG. 2, the representative application 234 allows the customer service representative 210 to send and receive indicator data, such that a match between the customer 202 and the customer service representative 210 may be made. The representative application 234 may allow for the communication device 224 of the customer service station system 208 to communicate the customer service representative indicators to the call center system 206. For example, the customer service representative 210 may have just had a stressful call with a customer 202. The customer service representative 210 may provide that data to the customer service station system 208, such that the call center application 222 does not predict a match with him and another customer 202 whose indications show him or her to be under stress. In one embodiment, the customer service representative 210 may manually input indicators on the customer service station system 208 via an interface, such as the one illustrated in FIG. 6. In another embodiment, the customer service station system 208 may automatically detect indicators such as voice data or the like without customer service representative 210 input. In this way, the representative application 234 may determine that the customer service representative 210 was just on a call with a customer 202 and the call was stressful, therefore the representative application 234 may provide this indicator data to the call center application 222 for matching the next customer 202.

In some embodiments, the representative application 234 may receive data from the call center application 222 regarding the analysis of the customer indicators. The data may then be provided to the customer service representative 210 via an interface, such as the interface illustrated in FIG. 6, displayed on the customer service station system 208. The indication may provide the customer service representative 210 results from the customer indicators that the customer service representative 210 may study prior to responding to the call from the customer 202. In this way, the customer service representative 210 may know the issue the customer 202 is calling in regards to and the customer indicators. The combination of the issue and the customer indicators may provide the customer service representative 210 an understanding as to why he was selected to field the customer's 202 call. In this way, once the customer service representative 210 responds to the call from the customer 202, the customer service representative 210 is prepared to answer any questions that the customer 202 may have.

The representative application 234 may also provide the customer service representative 210 the ability to communicate with the customer 202. The customer service representative 210, once accepting the request to respond to a call from a customer 202 may communicate with the customer 202 through the use of the customer service station system 208. The representative application 234 may receive indication of the customer service representative acceptance of a customer 202 call and request the communication device 224 to communicate with a customer 202, through the use of a customer device 204 over a network 201. In this way, the customer service representative 210 may communicate with the customer 202 using several different means of communication, including but not limited to voice communications, text communications, email communications, video communications, and/or the like.

The representative application 234 may further provide for customer service representative 210 access to the manufacturer system 203. The manufacturer system 203 may provide the customer service representative 210 detailed product and/or service information, troubleshooting information, return information, training, and/or the like. For example, a customer service representative 210 may wish to be trained to provide customer service for a specific product. In another example, the customer 202 may be contacting the call center regarding a complex product offered by the manufacturer. In this way, the customer service representative 210 may have had training from the manufacturer regarding the complex product and may also be able to access the manufacturer system 203 in order to obtain further information on the complex product to better assist the customer 202.

The customer device 204 is operatively coupled to the call center system 206, the customer service station system 208, and the manufacturer system 203 through the network 201. The customer device 204 has systems with devices the same or similar to the devices described for the call center system 206 and the customer service station system 208 (i.e., a communication device, a processing device, and a memory device). Therefore, the customer device 204 communicates with the call center system 206, the customer service station system 208, and/or the manufacturer system 203 in the same or similar way as previously described with respect to each system. The customer device 204, in some embodiments, provides the customer 202 with several different means of communication with a customer service representative 210, including but not limited to voice communications, text communications, email communications, video communications, and/or the like. In this way, there are several means in which a customer 202 may communicate with a customer service representative 210, such that the customer service representative 210 may provide assistance to the customer 202.

The manufacturer system 203 is operatively coupled to the call center system 206, the customer service station system 208, and the customer device 204 through the network 201. The manufacturer system 203 has systems with devices the same or similar to the devices described for the call center system 206 and the customer service station system 208 (i.e., a communication device, a processing device, and a memory device). Therefore, the manufacturer system 203 communicates with the call center system 206, the customer service station system 208, and/or the customer device 204 in the same or similar way as previously described with respect to each system. The manufacturer system 203, in some embodiments, is comprised of systems and devices that allow the call center system 206 and the customer service station system 208 to access manufacturer information, such as product and/or service information. The manufacturer system 203 may be a manufacturer of a product, provider of a service, financial institution, merchant, and/or the like.

Allowing access to product and/or service information from the manufacturer system 203 further provides the customer service representative 210 the means to quickly access product details, warranties, rebates, or manufacturer replacement information to discuss with the customer 202 if the need for such information arises. For example, the customer 202 may contact a call center and have a warranty issue regarding a product of a manufacturer. The manufacturer system 203 may be accessible by the customer service representative 210, so that the customer service representative 210 obtain updated warranty information for the customer 202 and even submit a warranty claim directly with the manufacturer on behalf of the customer 202.

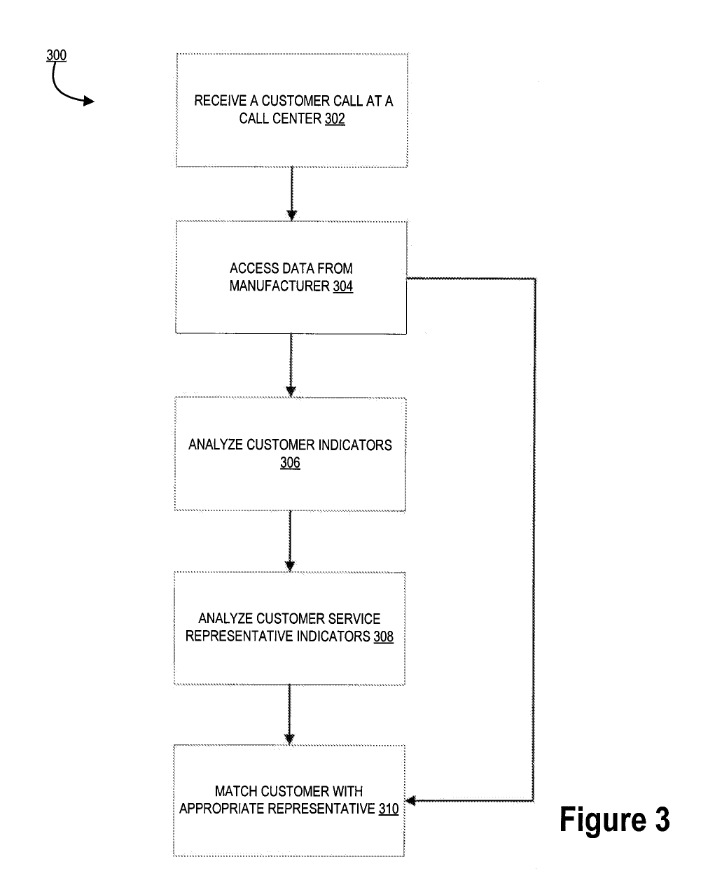

FIG. 3 illustrates a high level process flow for accessing manufacturer data for a customer service representative matching program 300. In block 302, the call center receives a call from a customer 202. Next, as represented in block 304, the call center system, through call center application 222, may access data from a manufacturer system 203. In one embodiment, the data from the manufacturer may be included in analyzing the customer indicators in block 306. Then in block 308, an analysis of customer service representative indicators may be provided. In block 310, once data from the manufacturer has been received and indicators from the customer 202 and the customer service representative 210 have been analyzed, the system may match a customer 202 with an appropriate customer service representative 210 based on the customer indicators and which customer service representative 210 has the expertise to provide the customer 202 with proper service. The matched customer calls may be placed in a queue for the customer service representative 210 to answer. In other embodiments, the data from the manufacturer accessed in block 304 may provide the necessary data to the call center system 206 for the system to match the customer 202 with an appropriate customer service representative in block 310, without analysis of customer or customer service representative indicators in blocks 306 or 308. Data from the manufacturer that may trigger the direct matching of customer 202 to appropriate customer service representative 210 may include data that indicates that only a few customer service representatives 210 are trained for providing service for the product the customer 202 is calling the call center for. In another example, a triggering event that may provide a direct match of a customer 202 with a customer service representative 210 when the customer 202 is wishing to pursue a warranty claim for a product and/or service.

Although only a single manufacturer system 203 is depicted in FIG. 2, the dynamic determination of appropriate representative program system and environment 200 may contain numerous manufacturer systems 203.

It is understood that the servers, systems and devices described herein illustrate one embodiment of the invention. It is further understood that one or more of the servers, systems, and devices can be combined in other embodiments and still function in the same or similar way as the embodiments described herein.

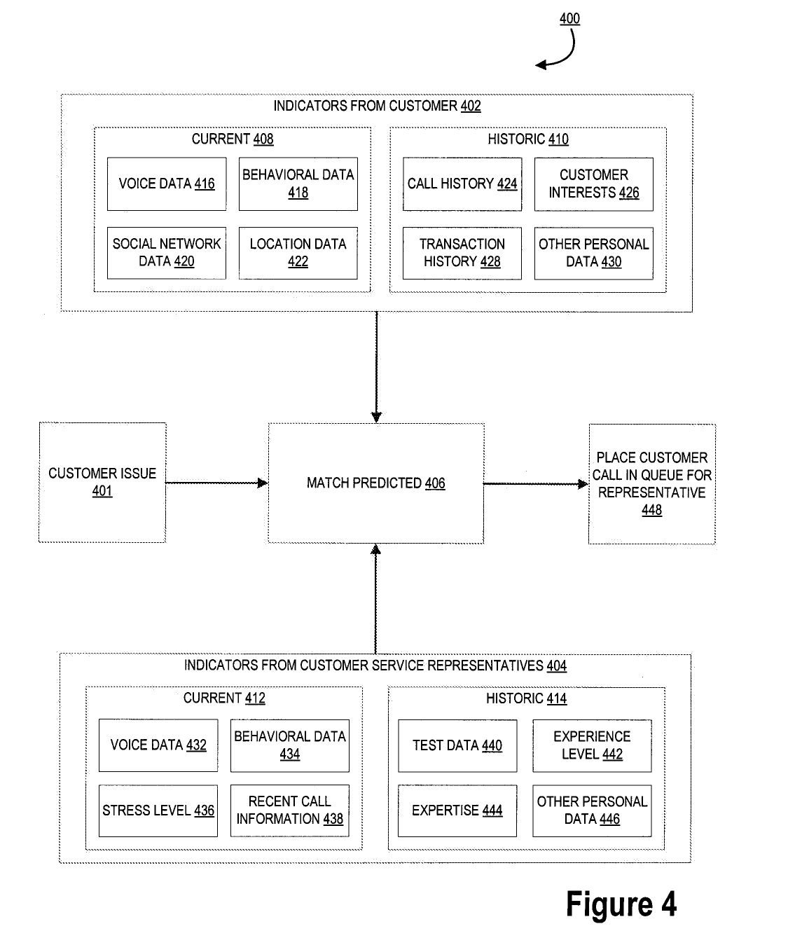

FIG. 4 illustrates a customer service representative matching program indicator analysis 400, in accordance with one embodiment of the invention. In block 401 the customer issue is determined. In this way, the call center system may provide an indication as to why the customer 202 is calling the call center to the customer service representative 210 and also aids the call center system 204 in predicting an appropriate customer service representative 210 to route the customer's call.

Receiving an indication as to why the customer 202 is calling the call center provides the call center with data to aid in predicting a match between the customer 202 and an appropriate customer service representative 210. The data may be regarding a specific product or service for which the call center receives a call from a customer 202. The data may include but is not limited to product or service defects, concerns, comments, warranty claims, repair requests, parts, service, etc. This data aids the call center system in determining the appropriate customer service representative 210 and preparing the customer service representative 210 for the customer 202 call. The data may aid in determining the appropriate customer service representative 210 if the product or service of issue is one that may need specific training in order to resolve the issue. As explained above, some products or services may require the customer service representative to have specialized training, such that the customer service representative 210 may be knowledgeable enough about the product or service to provide the customer 202 a satisfactory response with respect to the customer's issue. If specialized training is needed, there may be a limited number of customer service representatives 210 that may be able to respond to the customer's call. In this way, the customer issue, from block 401, may be queued for the customer service representative 210 with the appropriate training, without the need for indicator analysis.

In some embodiments, if such specialized training is required the customer call may be directed to a customer service representative 210 without indicator analysis. In other embodiments, if such specialized training is required the customer call may be directed to a customer service representative 210 after indicator analysis. In yet other embodiments, no specialized training may be required for a customer service representative 210 to respond to a customer call. In this way, indicators from both the customer 402 the customer service representative 404 may be analyzed. Customer and customer service representative indicator analysis may provide for an appropriate match to be made between a customer 202 and a customer service representative 210, such that the customer's issue is addressed appropriately and the customer 202 is provided the best possible call center experience, as represented in block 406.

As illustrated in FIG. 4, indicators from the customer 202 may be analyzed in block 402. Customer indicators 402 may include current 408 and historic 410 indicators. In block 404 indicators from the customer service representative may also be analyzed. Customer service representative indicators 404 may also include current 412 and historic 414 indicators. The indicators from both the customer 202 and the customer service representative 210 may predict the disposition of both the customer 202 and the customer service representative 210. In some embodiments, the indicators of the customer 202 or the customer service representative may be weighted, such that some indicators are more important in the determination of the individual's disposition than other indicators. In some embodiments, a match of a customer 202 and a customer service representative 210 may be provided based on the dispositions. In other embodiments, a match for a customer 202 and a customer service representative 210 may be provided based on the customer issue 401. In yet other embodiments, a match of a customer 202 and a customer service representative 210 may be provided based on a combination of the disposition of the customer 202, the disposition of the customer service representative 210, and/or the customer issue 401.

The individual's disposition may include, but is not limited to the individual's stress level, mood, anger level, or overall behavior. The disposition is measured by historical and current data indicators of both the customer 202 and the customer service representative 210. In this way, the customer 202 may be matched with the customer service representative 210 that would best support the customer 202 and prevent escalating anger of a customer 202.

As illustrated in FIG. 4, indicators from the customer 202 may be analyzed in block 402. Customer indicators 402 may include current 408 and historic 410 indicators. Current indicators 408 include, but are not limited to voice data 416, behavioral data 418, social network data 420, and location data 422. Current indicators 408 are determined in real-time or shortly thereafter. In this way, the call center system 206 may receive current data regarding the customer 202 to determine the customer's current disposition.

Voice data 416 may be captured and analyzed by the call center system 206 to determine the disposition of the customer 202. Voice data 416 may include, but is not limited to voice frequency, voice urgency, speech speed, the words used by the customer 202, and/or the like. The frequency of the customer's voice may provide an indication to the call center system 206 of the customer's disposition. For example, the customer 202, may contact the call center and be discussing an issue. The frequency of the customer's voice may be higher pitch than an average pitched voice, thus indicating that the customer 202 may be frustrated or nervous with the situation. In other examples, the customer 202 may be speaking quickly or speaking with urgency. In this way, the call center system 206 may recognize that the customer 202 wishes to resolve the issue quickly. This may prompt the call center system 206 to route the call to a customer service representative 210 quickly, thus to provide a positive call center experience for the customer 202. This may also prompt the call center system 206 to place the customer's call in a different location in the queue.

Behavioral data 418 may be determined from voice data 416 or other non verbal cues. Behavioral data 418 provides an indication as to the behavior the customer 202 may exhibit during communications with a customer service representative. Behaviors such as anger, frustration, furiousness, stress level, calmness, anxiety, etc. may be determined in this way. In one embodiment, voice data 416 may be used to determine behavioral data 418 of the customer 202. For example, if the customer 202 is calling the call center and communicating via voice communication, voice data 416 may be used to determine behavioral data 418. Other aspects of the voice communication, such as heavy breathing by the customer 202 or other indicators may be used to determine the customer's behavioral data 418. In other embodiments, behavioral data 418 may be determined by other means when the customer 202 communicates with the call center using a form of communication other than voice communication. For example, if the customer 202 communicates via a text form of communication, such as an email, text message, and/or the like, the call center system 206 may determine behavioral data 418 by analyzing the writing style of the customer 202. In one example, the customer 202 may write a well written informative text communication to the call center. This may provide an indication to the call center system 206 that the customer 202 is intelligent, calm, and rational. In another example, a text communication from a customer 202 to a call center may include typos, foul language, etc. This may provide an indication to the call center system 206 that the customer 202 is angry and it is an urgent matter for the customer 202.

Social network data 420 may include any data from a social networking site associated with the customer 202. Social networking sites, such as Facebook®, Twitter®, MySpace®, LinkedIn®, and/or the like provide a medium in which individual's may freely express their thoughts, schedule, interests, etc. The call center system 206 may access the customer's 202 social networking data through a network 201, such that the call center system 206 may be provided an indication as to the customer's hobbies, interests, vacation plans, and/or the like. This indication may provide useful data to the customer service representative 210 so that the customer service representative 210 may more knowledgeable in regards to the customer 202 and provide a potential means for defusing an escalating situation. For example, if the customer 202 indications show that he likes jazz music on his social networking pages, the call center system 206 may prompt jazz music to be played while the customer 202 is on hold. In yet another example, the call center system 206 may determine through the customer's social networking pages that he enjoys golf and has a golf vacation planned for later in the month. In this way, the customer service representative 210 may have the ability to offer the customer 202 a golf discount or other golf incentives in return for the issue that prompted the call to the call center. The customer service representative 210 may also enjoy golf, so the customer service representative 210 may initiate a conversation about golf in order to make the customer 202 feel more comfortable speaking to the customer service representative 210. Furthermore, the system may provide matches of friends on the customer's 202 social networking sites with friends on customer service representative 210 social network sites. For example, the customer 202 may be a friend with person 1. The customer service representative 210 may also be a friend, or a friend of a friend, of person 1. Therefore, the customer 202 may have a connection with that specific customer service representative 210 based on both of them being linked to person 1.

Location data 422 may also be a current indicator of customer 202 dispositions. Location data 422 may be provided to the call center system 206 by global positioning systems (“GPS”), locations based on of telephone numbers (i.e., caller identification systems), customer device 204 signals (i.e., cell phone positioning systems, IP address for internet access, etc.), and/or the like. Location data 422 may provide the customer service representative 210 information regarding the customer's disposition. For example, the customer 202 may live in Florida or another warm climate. However, the location data may indicate that the weather where the customer 202 is currently located is unseasonably cold and/or rainy. In this way, the call center system 206 may infer that the customer 202 may not be as happy to speak with the customer service representative 210 as the customer 202 would be if the weather suggested that it was a sunny day at the customer's current location.

As further illustrated in FIG. 4, indicators from the customer 202 may be analyzed in block 402. Customer indicators 402 may include current 408 and historic 410 indicators. Historic indicators 410 include, but are not limited to customer call history 424, customer interests 426, customer transaction history 428, and/or other personal data of the customer 430. Customer call history 424 may provide the call center system 206 with an indication of previous calls from the customer to the call center. In this way, the call center system 206 may recall the disposition of the customer 202 during those calls, the customer service representative 210 the customer 202 was connected with, and the outcome of those calls and use this data to match the customer 202 with an appropriate customer service representative 210. For example, on a previous call, the customer 202 may have been provided satisfactory customer service regarding his issue and had a positive experience with the customer service representative 210 the customer 202 communicated with. In this way, the call center system 206 may recall this data and, because of the positive experience, queue the same customer service representative to route the customer 202 call to. Call history 424 may also provide information to the call center system 206 if the customer 202 had a negative previous experience with the call center. In this way, the call center system 206 may queue a different customer service representative 210 or provide other changes to the customer's call center experience, so that the customer 202 may have a positive experience during this communication with the call center.

Customer interests 426 may be received by the call center system 206 in many ways. Customer interests 426 may include hobbies, sports, dinning, music, entertainment, etc. that the customer 202 may be interested in. Customer interests 426 may be determined from customer 202 communications, social networking data 420, Internet browser history of customer computer or customer device 204, location data 422, transaction history 428, the product or service of issue, and/or the like. In this way, several other indicators may provide information as to the customer interests 426. In one example, the customer 202 may communicate interests to the call center, such as telling an operator or customer service representative of an interest. In another example, the customer 202 may be contacting the call center because of defects in a product used for fishing, such as a fishing reel. In this way, the call center system 206 may infer that the customer 202 has an interest in fishing. If the call center system 206 is provided exact product information, the call center system 206 may determine the exact type of fishing (i.e., fly-fishing, salt water fishing, fishing for a specific species of fish, etc.). Customer interests 426 may also be provided by social network site information or customer Internet browsing history. In this way, the call center system 206 may learn that the customer 202 likes fishing. Thus, the customer service representative 210 may include fishing as a topic of discussion during communications with the customer 202. Further, the customer service representative 210 may have the authorization to provide the customer 202 with promotions for fishing products. If the customer 202 is extremely angry or upset regarding the issue the customer 202 is communicating with the call center about, the customer service representative 210 may have the authority to issue special promotions, such as discounts, coupons, gift cards, or the like to the customer 202, which may defuse the customer's anger and provide for a positive customer 202 experience.

Transaction history 428 may be determined by call center systems 206 that are uniquely situated with access to financial institution data. Transaction history 428 may provide the call center system 206 with information regarding customer interests 426 or transaction history 428 may provide information with respect to the product or service issue for which the customer 202 is calling the call center. For example, the call center may provide customer support for products A, B, and C. The customer's transaction history 428 may indicate that the customer 202 has recently purchased product B. Therefore, the call center system 206 may conclude that the customer 202 is contacting the call center for an issue with respect to product B. In this way, the customer service representative 210 may not have to ask the customer 202 for information regarding the product at issue, the customer service representative 210 may be provided this information prior to answering the customer 202 call.

Other personal data 430 may be provided by any of the other customer indicators 402. Other personal data 430 may include marital status, income, memberships, frequently shopped locations, education level, expertise associated with the product, etc. of the customer 202. The other personal data 430 may provide the customer service representative 210 other information regarding the customer 202 that may aid the customer service representative 210 in providing promotions to the customer 202, speaking with the customer 202 about interests of the customer 202, and/or being able to relate to the customer 202. In one example, a customer 202 may be calling about a mechanical product, the customer 202 may have has several years of job experience and education regarding mechanical engineering may be spoken to by a customer service representative 210 that is well versed in mechanical engineering, thus not to waste time discussing issues that the customer 202 may already know about the product. All of these may provide the customer 202 with a more positive call center experience.

In some embodiments, a single indicator is analyzed. In other embodiments, all indicators are analyzed. In yet other embodiments, some of the indicators are analyzed. Further, many indicators may provide the same and/or similar data, the indicators may overlap in analysis, or the indicators may provide conflicting indications. In this way, the call center system 206 may determine the most probable disposition of the customer 202 and subsequently provide the customer service representative 210 with information regarding the conflicting indications. Although, any number of indicators from the customer 202 may be analyzed, the call center system 206 or the customer service representative 210 may combine the results from the indicators during customer 202 communications. For example, the call center system 206 may provide information to the customer service representative 210 regarding customer indicators 402, such as the customer's location data 422 and the customer's interests 426. For example, the customer service representative 210 may be provided information regarding the customer's location as being northern Wisconsin and the customer's interests as being fishing 426. Because of this combination, the customer service representative 210 may discuss ice fishing for a specific type of fish located in northern Wisconsin or provide a promotion to the customer 202 based on these customer indications 402. By allowing the customer service representative 210 insights into the customer's interests, the customer service representative 210 may converse about the interests. This conversation may make the customer 202 feel relaxed and defuse any angry customer 202 or escalated frustrated situation.

As further illustrated in FIG. 4, indicators from the customer service representative 210 may also be analyzed in block 404. Customer service representative indicators 404 may include current 412 and historic 414 indicators. Current indicators 412 include, but are not limited to voice data 432, behavioral data 434, stress level 436, and recent call information 438. Current indicators 412 are determined in real-time or shortly thereafter. In this way, the call center system 206 may receive current data regarding the customer service representatives 210 to determine the customer service representatives' current disposition.

Voice data 432 may be captured and analyzed by the call center system 206 or the customer service station system 208 to determine the current disposition of the customer service representative 210. Voice data 432, similar to above with respect to customer indicators 402, may include, but is not limited to voice frequency, voice urgency, speech speed, the words used by the customer service representative 210, and/or the like. The frequency of the customer service representative's voice may provide an indication to the call center system 206 of the customer service representative's disposition. For example, the customer service representative 210 may have just completed three calls with irate or angry customers 202. The frequency of the customer service representative's voice may be enthusiastic in tone for the first call, but steadily decrease in enthusiasm towards the latter stages of the third call. In this way, the call center system 206 may recognized not to queue another angry or irate customer 202 to the customer service representative 210 for a specific period of time. In this way, the customer service representative 210 may recover from receiving several angry customers 202 in a row prior to fielding another angry customer 202 call.

Behavioral data 434 may be determined from voice data 432, non verbal cues, or customer service representative 210 manual input. Behavioral data 434 provides an indication as to the behavior the customer service representative 210 may exhibit during communications with a customer 202. Behaviors such as anger, frustration, furiousness, calmness, anxiety, etc. may be determined in this way. In one embodiment, voice data 432 may be used to determine behavioral data 434 of the customer service representative 210. In other embodiments, behavioral data 434 may be determined by other means. For example, the customer service representative 210 may indicate, via an interface, such as that illustrated in FIG. 6, that he is getting frustrated with the customers 202 he has fielded calls from. In this way, the call center system 206 may match and queue customers 202 that are calm, to the customer service representative 210. The customer service representative 210 may also indicate that he is calm and wishing to receive communications from customers 202 that may have an angry disposition, in a similar manner.

Stress level 436 may be determined from other indicators, such as voice data 432, or it may be manually inputted by the customer service representative 210 via the customer service station system 208, such as through an interface, like that illustrated in FIG. 6. Stress level of the customer service representative 210 may aid in determining the disposition of the customer service representative 210. If the stress level 436 of the customer service representative 210 is rated as high, then the call center system 206 may not queue a customer 202 that may add to the stress level of the customer service representative 210. For example, a customer service representative 210 may indicate that he has a high stress level because of the last few customer 202 calls he has fielded. Therefore, the call center system 206 may not queue a customer 202 with a type A personality and may add to the stress level of the customer service representative 210.

Recent call information 438 may provide the call center system 206 with information regarding the customer service representative 210 disposition, customers 202 that the customer service representative 210 has previously provided service to, the number of calls the customer service representative 210 has fielded within the last hour/day/week, and the experience level of the customer service representative 210. Recent call information 438 may provide an indication regarding the customer service representative 210 by analyzing the voice data 432 of the customer service representative 210 from the previous calls and recognize variations in the voice data 432 to indicate changes in disposition. Prior customers 202 that the customer service representative 210 has fielded may allow for the call center system 206 to queue that customer service representative 210 for that same customer 202, if the customer 202 had a good prior experience with the customer service representative 210. The number of calls the customer service representative 210 has fielded within the last hour/day/week may provide the call center system 206 data regarding the energy level of the customer service representative 210. For example, if the customer service representative 210 has fielded fifty calls within an hour, the call center system 206 may determine that the customer service representative 210 may need a break for receiving calls from customers 202. Therefore, the call center system 206 may not queue any customer 202 communications to the customer service representative 210. Finally, the recent call information 438 may provide the call center system 206 with data regarding the products and/or services that the customer service representative has had experience with recently. In this way, the call center system 206 may queue a customer 202 communications to a customer service representative 210 if the customer service representative 210 has recently fielded and subsequently provided a positive experience for the a different customer 202 for a related product or service.

As further illustrated in FIG. 4, indicators from the customer service representative 210 may be analyzed in block 404. Customer service representative indicators 404 may include current 412 and historic 414 indicators. Historic indicators 414 include, but are not limited to test data 440, experience level 442, expertise 444, and/or other personal data of the customer service representative 446. Test data 440 may include personality, risk assessment, stress level, or other tests administered by the call center. The test data 440 may be used to determine a baseline disposition for the customer service representatives 210. The test data 440 may also be used to establish personality or risk levels of the customer service representative 210, as to match the personality or risk level of the customer service representative 210 with a customer 202. In one example, a personality test may be administered and the customer service representative 210 may have a type A personality. In this way, the call center system 206 may not match that customer service representative 210 with a customer 202 with a conflicting personality, as determined by the customer indicators 402.

Experience level 442 may be determined by the call center system 206 by the seniority of the customer service representative 210. Seniority may be established by age, years working as a customer service representative, experience with specific products, education level, and the like. The call center system 206 may route specific high risk customers 202 to more experiences customer service representatives 210, such that the more experienced customer service representatives 210 may provide service to the customers 202 that may be angry, irate, or unresponsive.

Expertise 444 of the customer service representative 210 may be established by training, educational sessions, experience level 442, and/or test passing. The call center system 206 may determine that the customer 202 is calling in regard to a complex product. If this is the case, the customer service representative 210 fielding the customer 202 call regarding the product may need to have specialized training or experience dealing with that particular product, in order to better provide service to the customer 202. The call center system 206 may recognize the complexity of the product and/or the customer's issue with the product and queue the customer 202 call to a qualified customer service representative 210 based on the expertise 444 of the customer service representative 210. The customer service representative 210 may gain expertise 444 by attending training sessions offered by manufacturers, taking online courses offered through the manufacturers system 203, having experience with a specific product, by fielding several customer 202 calls related to a specific product, or passing tests that provides an indication of a customer service representative's 210 knowledge of a product or service. Furthermore, the expertise of the customer 202 may be matched with the customer service representative 210 such that the customer 202 and the customer service representative 210 may discuss the issue on the same intellectual level.

Other personal data 446 may be provided by manual input by the customer service representative 210, manual input by customer service representative 210 supervisors, or by other customer service representative indicators 404. Other personal data 446 may include, but is not limited to marital status, personal events, personal tragedies, social network data, memberships, frequently shopped locations, etc. The other personal data 446 may provide the call center system 206 with information regarding the customer service representative's disposition. For example, the customer service representative 210 may have recently had a death in the family. Therefore, the call center system 206 may not queue a call from a customer 202 to that customer service representative 210 if the customer's disposition is angry, irate, threatening, etc., which may cause tension between the customer service representative 210 and the customer 202.

In some embodiments, a single indicator is analyzed. In other embodiments, all indicators are analyzed. In yet other embodiments, some of the indicators are analyzed. In yet other embodiments, indicators are weighed prior to analysis, such that one indicator may be more important when inputted into the analysis. Further, many indicators may provide the same and/or similar data, the indicators may overlap in analysis, or the indicators may provide conflicting indications. In this way, the call center system 206 may determine the most probably disposition of the customer service representative 210 and queue customer 202 calls to the customer service representative 210 based on the indicators from both the customer 202 and the customer service representative 210.

Once the customer issue 401 has been determined, the indicators from the customer 402 have been analyzed, and the indicators from the customer service representatives 404 have been analyzed, a match between a customer 202 and a customer service representative 210 may be predicted, in block 406. Once a match is made in block 406 the customer call is placed in a queue for the customer service representative to accept the call, in block 448.

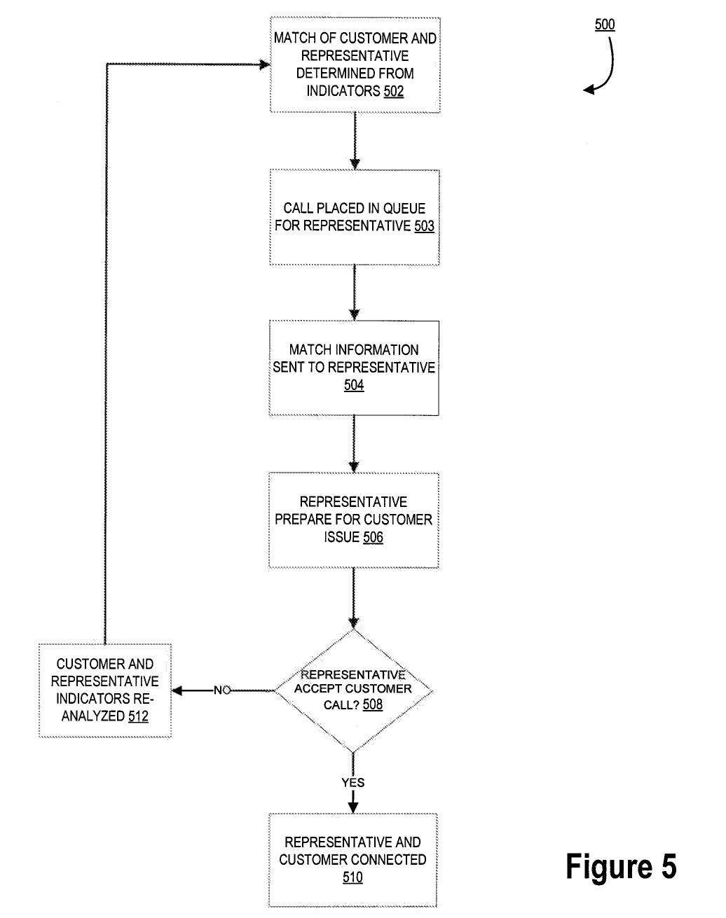

FIG. 5 illustrates a high level process flow illustrating a customer service representative matching program queuing process 500. Once the customer's issue has been identified and customer's indicators have been analyzed, the call center system 206 may match a customer 202 and a customer service representative 210 in block 502.

As illustrated in FIG. 5 at block 503, once a match is made between a customer 202 and a customer service representative 210 is made, in some embodiments, the call center system 206 may place the customer's call in a queue for that customer service representative 210 to answer. In other embodiments, the customer call is routed directly to the customer service representative 210 via the customer service station system 208 and not placed in a queue. Once the customer call is in the queue or is routed to the customer service representative 210, information regarding the match is sent to the customer service representative 210 for review, in block 504. Once the customer service representative 210 receives the information, the customer service representative 210 may prepare for the customer call and the issue the customer 202 may have, in block 506. The customer service representative 210 may prepare for the customer issue by examining an interface, such as a customer call interface 600, provided to the customer service station system 208 when the customer call is in the customer service representative 210 queue or routed to the customer service representative 210.

FIG. 6 illustrates a customer call interface 600 in accordance with embodiments of the present invention. The customer service representative 210 may receive the interface on the customer service station system 208 prior to accepting a customer call. In this way, the customer service representative 210 may receive an indication that a customer call is being routed to him 601, allows the customer service representative 210 time to review the customer's indication, and allows the customer service representative 210 time to review the customer's issue. In this way, the customer service representative 210 may have an indication as to why the customer 202 is contacting the call center. Section 602 provided the customer service representative 210 indications as to why the customer 202 is calling the call center. The reasons the customer 202 is calling the call center may be due to a product, service, manufacturer, or another reason. If the customer 202 is calling in regard to a product, below the product line of the reason the customer 202 is calling section 602 may be a detailed indication of the customer issue. For example, the customer 202 may be calling in regard to product A. But more specifically, the customer 202 may be calling regarding a defective clasp on product A. In the customer call interface 600 at section 602 the customer service representative 210 may be provided, not only the information regarding the product that the customer 202 is calling for, product A, but the issue which the customer 202 has with the product, the defective clasp. In this way the customer service representative 210 may be provided detailed information as to the issue that prompted the customer 202 to contact the call center.

Once the customer service representative 210 is provided an indication as to the reason the customer 202 is calling the call center in section 602, in section 604 the customer service representative 210 is provided information regarding customer disposition. The customer's information section 604 includes a disposition rating, the caller history, interests, and other data determined from customer indicators. The arbitrary rating, for example, may be a rating from one to ten, with one being considered a customer 202 who is reasonable and calm and ten being a considered a customer 202 who is angry and irrational. In this way, the customer service representative 210 may have a quick indicator as to the disposition of the customer 202. If the customer service representative 210 wishes to get more information regarding the customer 202, the remaining customer information 604 may provide the information to the customer service representative 210. The caller history provides the customer service representative 210 an indication as to whether the customer 202 has contacted the call center before and the outcome of that call, whether the customer 202 was satisfied with the service provided by the prior customer service representative 210 or not. The interests of the customer 202 may provide a conversation starter for the customer service representative 210. In this way, if the customer 202 is interested in sports, the customer service representative 210 may start the conversation with the customer 202 discussing last nights sports scores. This may relax the customer 202 and provide for a more appealing call center experience for the customer 202.

The customer service representative 210 may also provide indicators as to his disposition in section 606. A current disposition is listed for the customer service representative 210. The current disposition is the disposition that the call center system 206 has predicted by analyze the customer service representative 210 indicators. If the customer service representative 210 wishes to change the current disposition he may select to input indicators in section 610. In this way, the customer service representative 210 may select to change is disposition prior to the call center system 206 changing it via indicators.

The customer call interface 600 may also provide the customer service representative 210 with optional promotions to offer the customer 202. In section 608 the customer service representative 210 in this instance has three promotions to select from. The customer service representative 210 may offer all, some, or none of these promotions to the customer 202. The promotional offers are provided by the call center system 206 and are offers based on communications with the manufacturer system 203 and customer 202 indicators. For example, if the customer 202 is calling in regarding to a golf club recently purchased, the call center system 206 may provide the customer service representative 210, through the customer call interface 600, promotions for golf retailers, manufacturers, and/or courses. In some embodiments, the customer service representative 210 may have discretion as to whether to offer the customer 202 the promotions. In other embodiments, the call center system 206 indicates to the customer service representative 210 that the customer 202 may receive a promotion.

Once the customer service representative 210 has reviewed the customer call interface 600, the customer service representative 210 may accept the customer's call by selecting the accept customer call button 614. If the customer service representative 210 does so, the customer 202 is connected to the customer service representative 210 at that time. The customer service representative 210 may also decline the customer's call by selection the decline customer's call button 612.

As illustrated in FIG. 5, if the customer service representative 210 elects to accept the customer's call in decision block 508, the customer service representative 210 and the customer are connected to discuss the customer's issue, in block 510. However, if the customer service representative 210 elects not to accept the customer's call in decision block 508, the customer 202 and customer service representative 210 indicators are re-analyzed in block 512. Once the customer 202 indicators and customer service representative 210 indicators are analyzed the customer 202 may be matched with a different customer service representative 210 back in block 502.

Once the customer 202 and customer service representative 210 have completed the call, both the customer 202 and the customer service representative 210 may be able to provide feedback as to the effectiveness of the call. This may be in the form of a survey, questionnaire, or the like, such that the system may receive the survey and analyze the results. The analyzed results may be used in the future to better predict a customer 202 match to a customer service representative 210.

Furthermore, after the call has been completed the system may monitor other aspects of the customer 202 to determine if the call was effective. For example, the customer 202 may have contacted the customer service representative 210 in regards a product, product 1. The system may have noticed that since the call was placed, no new calls from the customer 202 were placed. Furthermore, the system may determine, from transaction data that the customer 202 has subsequently purchased more of product 1. In this way, the system may deduce that the call center experience was a positive, effective one for the customer 202.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for routing an incoming customer communication to a customer service station in a customer service network, said method comprising:
receiving an incoming customer communication;
determining a reason for the customer communication;
analyzing one or more customer indicators, through the use of a processing device, to predict the customer's disposition;
analyzing individual customer representative disposition indicators associated with one or more customer representatives to predict the one or more customer representative's disposition;
determining a selected customer representative having a predicted disposition that is predicted not to conflict with the customer's predicted disposition; and
routing the incoming customer communication to the customer service station associated with the selected customer representative.

2. The method of claim 1, wherein determining the reason for the customer communication is based at least in part on customer transaction history.

3. The method of claim 2, wherein customer transaction history includes prior purchases of the customer.

4. The method of claim 3, wherein the prior purchases of the customer are purchases for products, wherein customer service for the products is provided by the customer representative of the customer service network.

5. The method of claim 3, wherein the prior purchases of the customer are purchases for services, wherein customer service for the service is provided by the customer representative of the customer service network.

6. The method of claim 1, wherein customer indicators include voice frequency of the customer, such that a prediction is made from the customer's voice frequency as to the customer's disposition.

7. The method of claim 1, wherein customer indicators further include customer calling history, such that the disposition of the customer during prior communications provide a prediction of the customer's disposition during a subsequent communication.

8. The method of claim 1, wherein customer indicators further include customer Internet browsing, such that social network data or browsing data of the customer provides a prediction of the customer's disposition.

9. The method of claim 1, wherein customer representative indicators include an analysis of recent customer representative communications with customers, such that an indication is provided of the customer representative disposition based on an outcome of recent customer communications.

10. The method of claim 1, wherein customer representative indicators further include personality test data of the customer representatives.

11. The method of claim 1, wherein the customer representative is an individual

12. The method of claim 1, wherein the customer representative is an automated voice system.

13. The method of claim 1 further comprising providing the selected customer representative information regarding the customer's disposition, such that the selected customer representative is prepared for the customer when the customer communication is routed to the customer service station of the selected customer representative.

14. The method of claim 1 further comprising allowing the selected customer representative, in response to the information received regarding the customer's disposition, to accept the routed communication from the customer.

15. A system for routing an incoming customer communication to a customer service station in a customer service network, said system comprising:
a memory device;
a communication device; and
a processing device communicably coupled to the communication device and the memory device, wherein the processing device is configured to:
receive an incoming customer communication;
determine a reason for the customer communication;
analyze one or more customer indicators to predict the customer's disposition;
analyze individual customer representative disposition indicators associated with one or more customer representatives to predict the one or more customer representative's disposition;
determine a selected customer representative having a predicted disposition that is predicted to not conflict with the customer's predicted disposition; and
route the incoming customer communication to the customer service station associated with the selected customer representative.

16. The system of claim 15, wherein determining the reason for the customer communication is based at least in part on customer transaction history.

17. The system of claim 16, wherein customer transaction history includes prior purchases of the customer.

18. The system of claim 17, wherein the prior purchases of the customer are purchases for products, wherein customer service for the products is provided by the customer representative of the customer service network.

19. The system of claim 17, wherein the prior purchases of the customer are purchases for services, wherein customer service for the service is provided by the customer representative of the customer service network.

20. The system of claim 15, wherein customer indicators include voice frequency of the customer, such that a prediction is made from the customer's voice frequency as to the customer's disposition.

21. The system of claim 15, wherein customer indicators further include customer calling history, such that the disposition of the customer during prior communications provide a prediction of the customer's disposition during a subsequent communication.

22. The system of claim 15, wherein customer indicators further include customer Internet browsing, such that social network data or browsing data of the customer provides a prediction of the customer's disposition.

23. The system of claim 15, wherein customer representative indicators include an analysis of recent customer representative communications with customers, such that an indication is provided of the customer representative disposition based on an outcome of recent customer communications.

24. The system of claim 15, wherein customer representative indicators further include personality test data of the customer representatives.

25. The system of claim 15, wherein the customer representative is an individual

26. The system of claim 15, wherein the customer representative is an automated voice system.

27. The system of claim 15, wherein the processing device is further configured to execute computer-readable program code to provide the selected customer representative information regarding the customer's disposition, such that the selected customer representative is prepared for the customer when the customer communication is routed to the customer service station of the selected customer representative.

28. The system of claim 15, wherein the processing device is further configured to execute computer-readable program code to allow the selected customer representative, in response to the information received regarding the customer's disposition, to accept the routed communication from the customer.

29. A computer program product comprising at least one computer-readable medium having computer-readable program code portions embodied therein, the computer readable program code portions comprising:
an executable portion configured for receiving an incoming customer communication;
an executable portion configured for determining a reason for the customer communication;
an executable portion configured for analyzing one or more customer indicators to predict the customer's disposition;
an executable portion configured for analyzing individual customer representative disposition indicators associated with one or more customer representatives to predict the one or more customer representative's disposition;
an executable portion configured for determining a selected customer representative having a predicted disposition that is predicted to not conflict with the customer's predicted disposition; and
an executable portion configured for routing the incoming customer communication to the customer service station associated with the selected customer representative.

30. The computer program product of claim 29, wherein determining the reason for the customer communication is based at least in part on customer transaction history.

31. The computer program product of claim 30, wherein customer transaction history includes prior purchases of the customer.

32. The computer program product of claim 31, wherein the prior purchases of the customer are purchases for products, wherein customer service for the products is provided by the customer representative of the customer service network.

33. The computer program product of claim 29, wherein the prior purchases of the customer are purchases for services, wherein customer service for the service is provided by the customer representative of the customer service network.

34. The computer program product of claim 29, wherein customer indicators include voice frequency of the customer, such that a prediction is made from the customer's voice frequency as to the customer's disposition.

35. The computer program product of claim 29, wherein customer indicators further include customer calling history, such that the disposition of the customer during prior communications provide a prediction of the customer's disposition during a subsequent communication.

36. The computer program product of claim 29, wherein customer indicators further include customer Internet browsing, such that social network data or browsing data of the customer provides a prediction of the customer's disposition.

37. The computer program product of claim 29, wherein customer representative indicators include an analysis of recent customer representative communications with customers, such that an indication is provided of the customer representative disposition based on an outcome of recent customer communications.

38. The computer program product of claim 29, wherein customer representative indicators further include personality test data of the customer representatives.

39. The computer program product of claim 29, wherein the customer representative is an individual

40. The computer program product of claim 29, wherein the customer representative is an automated voice system.

41. The computer program product of claim 29 further comprising an executable portion configured for providing the selected customer representative information regarding the customer's disposition, such that the selected customer representative is prepared for the customer when the customer communication is routed to the customer service station of the selected customer representative.

42. The computer program product of claim 29 further comprising an executable portion configured for allowing the selected customer representative, in response to the information received regarding the customer's disposition, to accept the routed communication from the customer.
